(19) United States
(12) Patent Application Publication
(10) Pub. No.: US 2006/0197902 A1
(43) Pub. Date: Sep. 7, 2006

(54) Liquid crystal display substrate having peripheral sealant adhering structure

(75) Inventors: Hung-Sheng Cho, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/369,332

(22) Filed: Mar. 6, 2006

(30) Foreign Application Priority Data
Mar. 4, 2005 (TW) 94106535

(51) Int. Cl. G02F 1/1339

(52) U.S. Cl. 349/153

(57) ABSTRACT

A liquid crystal display substrate (100) includes a base portion (110), an alignment layer (118) provided on the base portion, and a peripheral sealant adhering structure (114) provided on the base portion at a periphery of the alignment layer. The sealant adhering structure includes a filler layer. Because the alignment layer and the filler layer are exactly or at least substantially flush, when the alignment layer is rubbed, few if any abnormities occur at peripheral edge portions of the alignment layer that are adjacent an inmost extremity of the filler layer. In particular, few if any so-called stripes are formed at the peripheral edge portions of the alignment layer. Therefore, the quality of the LCD substrate and of a display of the LCD are improved.

### BACKGROUND

1. Field of the Invention

The present invention relates to a liquid crystal display (LCD) substrate.

2. General Background

During the process of fabricating an LCD, alignment layers are generally formed on the two substrates of the LCD, and then the alignment layers are rubbed. A typical fabricating process for an LCD includes the following steps: forming electrodes on a pair of substrates; coating two alignment layers on the substrates respectively, and rubbing the alignment layers; distributing spacers on the substrates; coating a sealant on one of the substrates; adhering the two substrates together; cutting the substrates into a plurality of cells each having a predetermined size; injecting liquid crystal into each of the cells; and sealing each of the cells.

Referring to FIG. 21, the function of the alignment layers is shown. Section A enclosed by a dashed line illustrates irregularly arranged liquid crystal molecules 2 of a liquid crystal layer of a typical LCD (not shown) that does not provide alignment layers. Section B enclosed by another dashed line illustrates liquid crystal molecules 2 aligned by alignment layers (not shown) that abut top and bottom extremities of the liquid crystal layer. It can be seen that the aligned liquid crystal molecules 2 are regularly arranged and have approximately a same pretilt angle.

During manufacture, the alignment layers are generally rubbed so that they are able to provide predetermined pretilt angles. The rubbing process involves using a rubbing cloth, ion beams, ultraviolet radiation, or other suitable means. FIG. 22 shows the use of a rubbing cloth 11 of a rubbing device to rub an LCD substrate 13. The LCD substrate 13 is mounted on a working table 12 of the rubbing device. The LCD substrate 13 defines an alignment layer region having an alignment layer 131 formed thereon, and a peripheral sealant adhering region 132 at a periphery of the alignment layer region. That is, because adhesiveness between a sealant and the alignment layer 131 is generally poor, the alignment layer 131 does not cover the sealant adhering region 132. FIG. 23 shows the LCD substrate 13 prior to rubbing of the alignment layer 131. The rubbing cloth 11 is wrapped on a roller 10 of the rubbing device. The roller 10 rolls along a predetermined direction and causes the rubbing cloth 11 to rotate in contact with the alignment layer 131, thereby rubbing the alignment layer 131.

Because the sealant adhering region 132 of the LCD substrate 13 is bare, the alignment layer 131 forms a step where it adjoins the sealant adhering region 132. Therefore when the roller 10 passes over edge portions of the alignment layer 131 at the step, the rubbing cloth 11 creates so-called stripes 138 at the edge portions of the alignment layer 131, as shown in FIG. 24. As a result, the quality of a display of the LCD is degraded at regions of the display corresponding to the stripes 138 on the alignment layer 131 of the LCD substrate 13.

Therefore, a new liquid crystal display substrate that can overcome the above-described problems are desired.

### SUMMARY

In a first embodiment, a liquid crystal display substrate includes a base portion, an alignment layer provided on the base portion, and a peripheral sealant adhering structure provided on the base portion at a periphery of the alignment layer. The sealant adhering structure includes a filler layer.

In a second embodiment, a liquid crystal display substrate includes a base portion, an alignment layer provided on the base portion, and a peripheral sealant adhering structure provided on the base portion at a periphery of the alignment layer. The sealant adhering structure includes an alignment pattern.

Other advantages and novel features will become more apparent from the following detailed description when taken in conjunction with the accompanying drawings.

### BRIEF DESCRIPTION OF THE DRAWINGS

FIG. 1 is a schematic, top plan view of an LCD substrate according to a first embodiment of the present invention.

FIGS. 2-8 are each schematic, enlarged views of part of the LCD substrate shown in FIG. 1, each showing a different configuration of a filler layer of the LCD substrate.

FIGS. 9-14 are each schematic, enlarged, side cross-sectional views of part of the LCD substrate shown in FIG. 1, each showing a different configuration of the filler layer of the LCD substrate.

FIG. 15 is a schematic, side cross-sectional view of part of an LCD substrate according to a second embodiment of the present invention, the LCD substrate including a peripheral alignment pattern.

FIGS. 16-20 are each schematic, cross-sectional views of part of an LCD substrate similar to the one shown in FIG. 15, but each showing a different configuration of the alignment pattern in cooperation with a filler layer.

FIG. 21 is a schematic, side view of liquid crystal molecules as they would be seen in a liquid crystal layer of a typical LCD, when the LCD does not provide alignment layers (Section A) and when the LCD does provide alignment layers (Section B).

FIG. 22 is a schematic, side view showing a rubbing cloth on a roller of a typical rubbing device being used to rub an alignment layer of an LCD substrate mounted on a working table.

FIG. 23 is a schematic, top plan view of a conventional LCD substrate including an alignment layer formed thereon.

FIG. 24 is similar to FIG. 23, but showing the LCD substrate after the alignment layer has been rubbed by the rubbing device shown in FIG. 22.

### DETAILED DESCRIPTION OF PREFERRED EMBODIMENTS

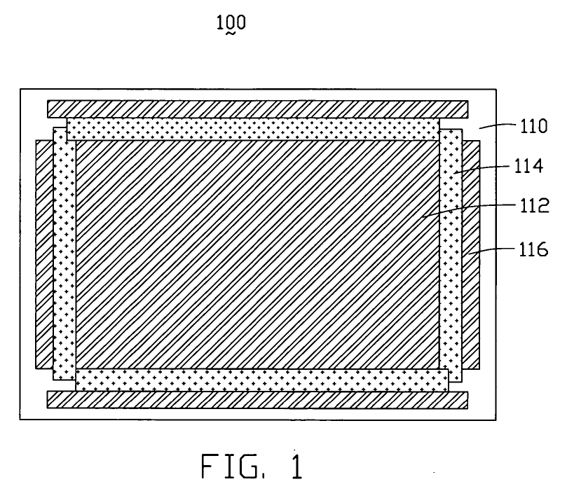

Referring to FIG. 1, an LCD substrate 100 according to a first embodiment of the present invention includes a base portion 110. The base portion 110 defines an active region 112 having a combination 115 of active elements formed thereon, an edge region 116 surrounding the active region 112, and a sealant adhering region 114 between the active region 112 and the edge region 116. The active elements include components used to control transmission of light through an LCD that incorporates the LCD substrate 100, as known in the art. A transverse width of the sealant adhering region 114 is typically in the range from 1˜12 mm.

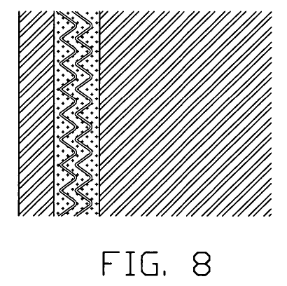

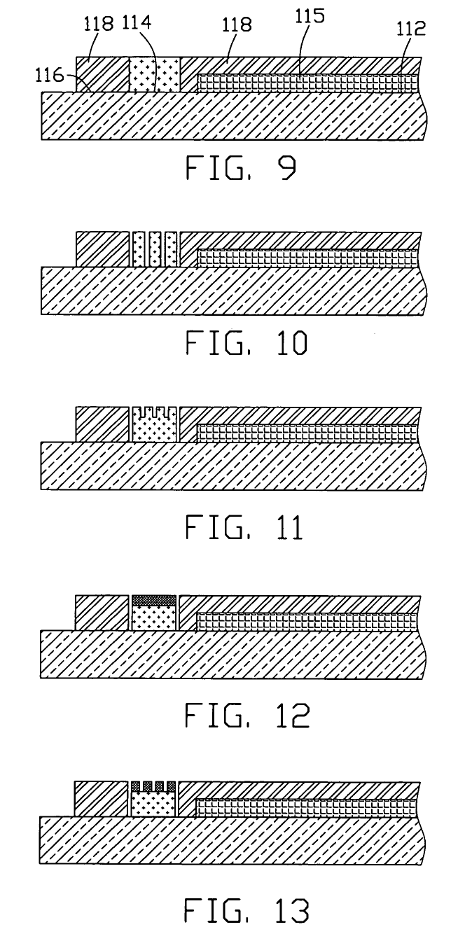

Referring also to FIG. 9, the active region 112 having the combination 115 and the edge region 116 are covered by an alignment layer 118. The sealant adhering region 114 includes a filler layer formed thereon. The filler layer has a thickness substantially equal to or slightly less than that of the alignment layer 118. Preferably, the thickness of the filler layer is equal to that of the alignment layer 118, so that the alignment layer 118 and the filler layer are exactly or at least substantially flush. The filler layer has a coefficient of friction substantially identical to that of the alignment layer 118. Further, the filler layer has a strong adhesiveness with a sealant that is subsequently used to join the LCD substrate 100 with a second LCD substrate of the LCD. Typically, a material of the filler layer is selected from the group consisting of silicon nitride, silicon dioxide, indium-tin oxide, indium-zinc oxide, chromium, molybdenum, aluminum, rubidium, copper, metal alloy, acrylate, polyester, polyethylene, and polyimide.

Because the alignment layer 118 and the filler layer are exactly or at least substantially flush, when the alignment layer 118 is rubbed, few if any abnormities occur at peripheral edge portions of the alignment layer 118 that are adjacent an inmost extremity of the filler layer. In particular, few if any so-called stripes are formed at the peripheral edge portions of the alignment layer 118. Therefore, the quality of the LCD substrate 100 and of a display of the LCD are improved.

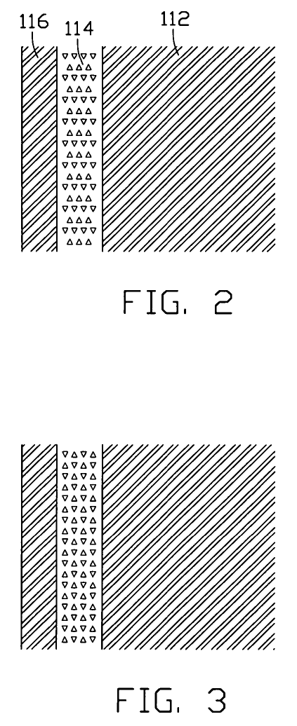

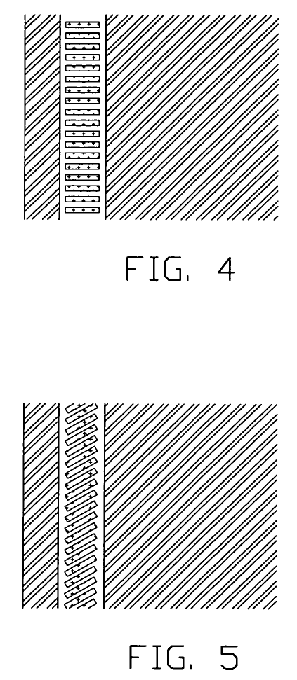

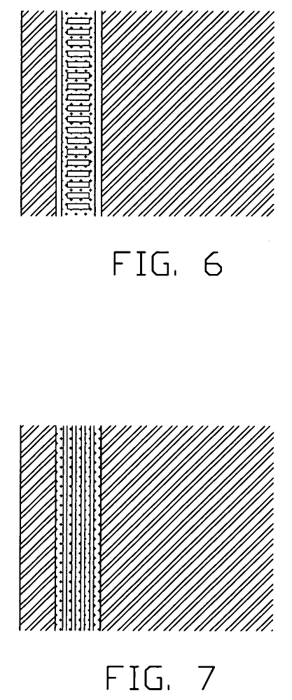

The filler layer may be a continuous, solid body of material, such as is shown in FIG. 9. Alternatively, the filler layer may have various other configurations, such as a pattern of oppositely arranged triangular portions as shown in FIG. 2, a pattern of alternately arranged triangular portions as shown in FIG. 3, a pattern of parallel transverse rectangular portions as shown in FIG. 4, or a pattern of parallel oblique rectangular portions as shown in FIG. 5. Alternatively, the filler layer may be a continuous, solid body of material that defines a plurality of grooves therein. The grooves may or may not span a full depth of the filler layer. For example, the filler layer may include a pattern of parallel transverse rectangular grooves together with an inmost peripheral long groove and an outmost peripheral long groove as shown in FIG. 6, a pattern of parallel rectilinear long grooves as shown in FIG. 7, or a pair of parallel wavy long grooves as shown in FIG. 8.

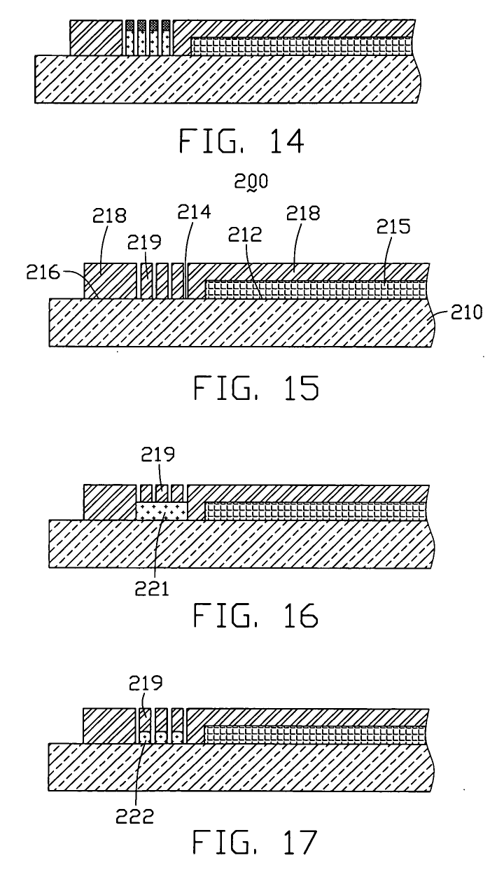

The filler layer can have still other various configurations as follows. Referring to FIG. 10, the filler layer may include a plurality of parallel ribs, with grooves between the ribs completely separating adjacent ribs. Referring to FIG. 11, the filler layer may include a plurality of parallel rib portions formed on a common base portion. Referring to FIG. 12, the filler layer may include a continuous, solid bottom portion of a first material, and a continuous, solid top portion of a second material formed on the bottom portion. Referring to FIG. 13, the filler layer may include a continuous, solid bottom portion of a first material, and a plurality of parallel top ribs of a second material formed on the bottom portion. Referring to FIG. 14, the filler layer may include a plurality of parallel bottom ribs of a first material, and a plurality of parallel top ribs of a second material formed on the bottom ribs.

Referring to FIG. 15, an LCD substrate 200 according to a second embodiment of the present invention includes a base portion 210. The base portion 210 defines an active region 212 having a combination 215 of active elements formed thereon, an edge region 216 surrounding the active region 212, and a sealant adhering region 214 between the active region 212 and the edge region 116. The active elements include components used to control transmission of light through an LCD that incorporates the LCD substrate 200, as known in the art. The active region 212 having the combination 215 and the edge region 216 are both covered by an alignment layer 218. The sealant adhering region 214 has a ribbed alignment pattern 219 formed thereon. The alignment pattern 219 is made from a material identical to a material from which the alignment layer 218 is made. A top plan area of ribs of the alignment pattern 219 is 25˜75% that of a top plan area of the sealant adhering region 214. Preferably, the top plan area of the ribs of the alignment pattern 219 is 50% of the top plan area of the sealant adhering region 214.

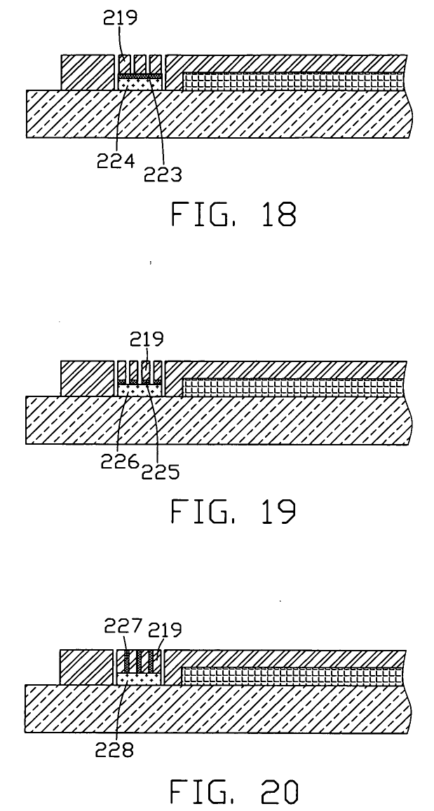

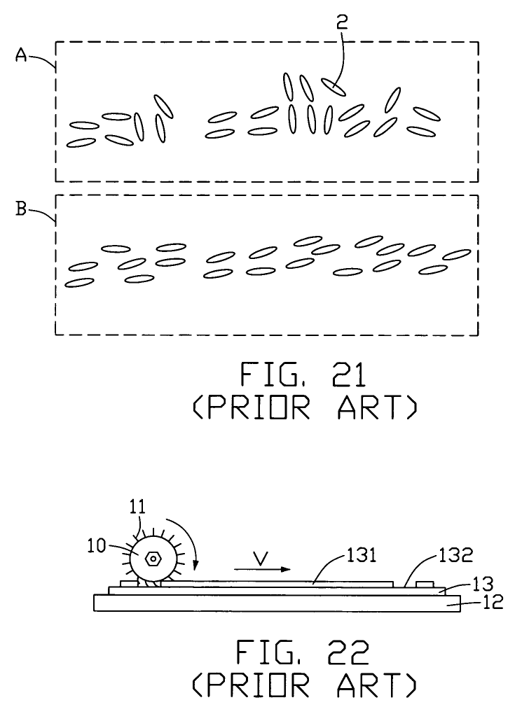

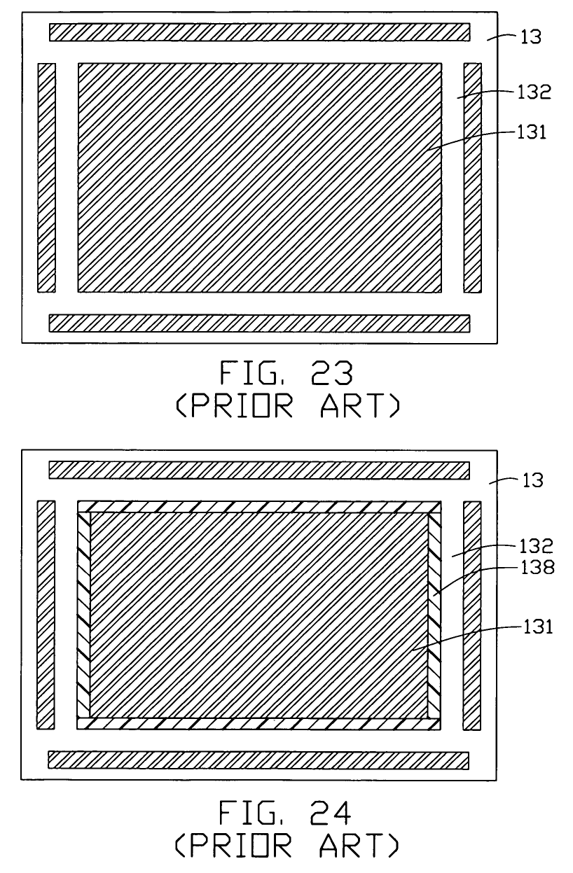

In alternative embodiments, the alignment pattern 219 can be disposed on a filler layer. The filler layer is made from any of the same materials as those described above in relation to the first embodiment. Various arrangements of the alignment pattern 219 and the filler layer can be as follows. Referring to FIG. 16, a filler layer 221 is a continuous, solid body of material, and supports the ribs of the alignment pattern 219. Referring to FIG. 17, a filler layer 222 includes a plurality of ribs, each of which supports a corresponding rib of the alignment pattern 219. Referring to FIG. 18, a filler layer 224 is a continuous, solid body made from a first material. An intermediate layer 223 is interposed between the alignment pattern 219 and the filler layer 224. The intermediate layer 223 is a continuous, solid body of a second material, and supports the ribs of the alignment pattern 219. Referring to FIG. 19, a filler layer 226 is a continuous, solid body made from a first material. An intermediate layer 225 is interposed between the alignment pattern 219 and the filler layer 226. The intermediate layer 225 is made from a second material, and includes a plurality of ribs each of which supports a corresponding rib of the alignment pattern 219. Referring to FIG. 20, a filler layer 228 is a continuous, solid body made from a first material. The ribs of the alignment pattern 219 and ribs of an interleaving layer 227 are alternately arranged on the filler layer 228. The interleaving layer 227 is made from a second material.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display substrate comprising:
a base portion;
an alignment layer provided on the base portion; and
a peripheral sealant adhering structure provided on the base portion at a periphery of the alignment layer, the sealant adhering structure comprising a filler layer.

2. The liquid crystal display substrate as claimed in claim 1, wherein the sealant adhering structure and the alignment layer are at least substantially flush.

3. The liquid crystal display substrate as claimed in claim 1, wherein the filler layer has a coefficient of friction substantially identical to that of the alignment layer.

4. The liquid crystal display substrate as claimed in claim 1, wherein a material of the filler layer comprises one or more items selected from the group consisting of silicon nitride, silicon dioxide, indium-tin oxide, indium-zinc oxide, chromium, molybdenum, aluminum, rubidium, cuprum, metal alloy, acrylate, polyester, polyethylene, and polyimide.

5. The liquid crystal display substrate as claimed in claim 1, wherein the filler layer comprises a pattern of triangular portions, a pattern of rectangular portions, or a pattern of triangular portions and rectangular portions.

6. The liquid crystal display substrate as claimed in claim 1, wherein the filler layer defines a plurality of grooves.

7. The liquid crystal display substrate as claimed in claim 6, wherein the grooves comprise one or more items selected from the group consisting of parallel transverse grooves, parallel peripheral grooves, parallel long grooves, and wavy grooves.

8. The liquid crystal display substrate as claimed in claim 1, wherein the sealant adhering structure further comprises a ribbed alignment pattern, and the alignment pattern comprises a plurality of ribs disposed on the filler layer.

9. The liquid crystal display substrate as claimed in claim 1, wherein a material of the alignment pattern is the same as that of the alignment layer.

10. The liquid crystal display substrate as claimed in claim 8, wherein a total area of the ribs of the alignment pattern is in the range from 25˜75% of a total area of the sealant adhering structure.

11. The liquid crystal display substrate as claimed in claim 10, wherein the total area of the alignment pattern is approximately 50% of the total area of the sealant adhering structure.

12. The liquid crystal display substrate as claimed in claim 1, further comprising a peripheral edge structure at a periphery of the sealant adhering structure.

13. The liquid crystal display substrate as claimed in claim 1, wherein a transverse width of the sealant adhering structure is in the range from 1˜12 millimeters.

14. A liquid crystal display substrate comprising:
a base portion;
an alignment layer provided on the base portion; and
a peripheral sealant adhering structure provided on the base portion at a periphery of the alignment layer, the sealant adhering structure comprising an alignment pattern.

15. The liquid crystal display substrate as claimed in claim 14, wherein the peripheral sealant adhering structure and the alignment layer are at least substantially flush.

16. The liquid crystal display substrate as claimed in claim 14, wherein the alignment pattern is ribbed.

17. The liquid crystal display substrate as claimed in claim 14, wherein the alignment pattern is made from a same material as that of the alignment layer.

18. A liquid crystal display substrate comprising:
a base portion;
an alignment layer provided on the base portion; and
a peripheral sealant adhering structure provided on the base portion at a periphery of the alignment layer, the sealant adhering structure comprising two layers in a vertical direction, of which one is of a unitary manner while the other is of discrete manner.
